(19) United States
(12) Patent Application Publication
(10) Pub. No.: US 2020/0166139 A1
(43) Pub. Date: May 28, 2020

(54) SEALS AND ASSEMBLIES WITH SEALS

(71) Applicant: SAINT-GOBAIN PERFORMANCE PLASTICS CORPORATION, Solon, OH (US)

(72) Inventors: Hongyan WANG, Shanghai (CN); Tao HE, Shanghai (CN); Wei WEI, Shanghai (CN); Si JIN, Shanghai (CN)

(21) Appl. No.: 16/691,742

(22) Filed: Nov. 22, 2019

(30) Foreign Application Priority Data
Nov. 22, 2018 (CN) 201811400537.1

(51) Int. Cl. F16J 15/3236; F16J 15/02

(52) U.S. Cl. CPC F16J 15/3236; F16J 15/025

(57) ABSTRACT

An annular seal comprising: a central section; a first seal interface extending from a first axial side of the central section; and a second seal interface extending from a second axial side of the central section, wherein the first and second seal interfaces each include less than three sealing lips, and wherein at least a portion of the central section is adapted to be spaced apart from a surface of a hardware in an installed state.

### CROSS-REFERENCE TO RELATED APPLICATION(S)

This application claims priority under 35 U.S.C. § 119(e) to Chinese Patent Application No. 201811400537.1 entitled “SEALS AND ASSEMBLIES WITH SEALS,” by Hongyan WANG et al., filed Nov. 22, 2018, which is assigned to the current assignee hereof and incorporated herein by reference in its entirety.

### FIELD OF THE DISCLOSURE

The present disclosure relates to seals and assemblies including seals.

### RELATED ART

Seals are generally utilized to isolate fluids from one another or maintain differential pressures within an assembly. For instance, in some hardware seals may be introduced between two or more components to isolate two or more areas of the hardware from one another. In a particular instance, seals can be utilized between inner components and outer components of hardware to isolate first regions of the hardware from second regions of the hardware.

As manufacturing capabilities and design technology have advanced, there has become an increased need for new seal designs capable of operating effectively within more extreme environments. More specifically, mechanical industries, such as the automotive industry, continue to demand improved seals adapted to operate within and maintain higher pressure differentials.

### BRIEF DESCRIPTION OF THE DRAWINGS

Embodiments are illustrated by way of example and are not intended to be limited in the accompanying figures.

FIG. 1 includes a schematic view of a common rail system in accordance with an embodiment.

FIG. 2 includes a cross-sectional view of a pump in accordance with an embodiment.

FIG. 3 includes a cross-sectional view of a seal in accordance with an embodiment as viewed in a hardware.

FIG. 4 includes a cross-sectional view of a seal in accordance with another embodiment as viewed in a hardware.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The terms “generally,” “substantially,” “approximately,” and the like are intended to cover a range of deviations from the given value. In a particular embodiment, the terms “generally,” “substantially,” “approximately,” and the like refer to deviations in either direction of the value within 10% of the value, within 9% of the value, within 8% of the value, within 7% of the value, within 6% of the value, within 5% of the value, within 4% of the value, within 3% of the value, within 2% of the value, or within 1% of the value.

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the sealing arts.

In a particular aspect, a seal in accordance with an embodiment described herein can be an annular seal. The annular seal can include a central section and a first and second seal interface extending from first and second axial sides of the annular section. In an embodiment, the first and second seal interfaces can each include less than three sealing lips. In another embodiment, at least a portion of the central section can be adapted to be spaced apart from a surface of a hardware in an installed state.

In an embodiment, at least one of the first and second seal interfaces includes an energizing element, such as a spring. In an embodiment, the second seal interface can include an energizing element and the first seal interface can be essentially free of an energizing element. In a particular instance, the seal can be adapted to be disposed between a first region of a hardware and a second region of the hardware, wherein the first region has a higher pressure than the second region. The second seal interface can be adapted to be disposed on the side of the seal closer to the first region.

In certain instances, the sealing lip can include an edge lip adjacent to an axial end of the seal and a secondary lip spaced apart from the edge lip by a recessed portion. The recessed portion can have a generally polygonal cross-sectional shape. In an embodiment, the recessed portion can include a first surface and a second surface, as viewed in cross section, where the first surface is disposed closer to the edge lip and the second surface is disposed closer to the secondary lip. The first surface can be bigger than the second surface. In an embodiment, the edge lip can be spaced apart from an axial end of the seal by a chamfered edge of the seal.

In an embodiment, the seal can include a first axial length, as measured along an outer surface of the seal, and a second axial length, as measured along an inner surface of the seal, that are different from one another.

In certain instances, the central section of the seal can include a concave cross-sectional profile. In an embodiment, a smallest thickness of the seal, as measured perpendicular to the axial length of the seal, can be disposed in the central section of the annular seal.

In accordance with another aspect, a sealed assembly can generally include an outer component defining a bore and an inner component disposed within the bore of the outer component. An annular seal can be disposed between the inner and outer components. In an embodiment, the seal can include a central section and first and second seal interfaces extending from the central section. In certain instances the first and second seal interfaces can each include less than there sealing lips. In an embodiment, at least a portion of the central section of the seal is spaced apart from a surface of the inner component. In a more particular embodiment, all of the central section can be spaced apart from the surface of the inner component.

In an embodiment, the inner component can be adapted to rotate relative to the outer component. In another embodiment, the inner component can be adapted to translate, such as reciprocate, relative to the outer component. In yet a further embodiment, the inner component can be adapted to rotate and translate relative to the outer component.

In an embodiment, the first seal interface can be in fluid communication with a first region of the assembly and the second seal interface can be in fluid communication with a second region of the assembly. The first region can have a higher pressure than the second region. In certain instances, the second seal interface can include an energizing element and the first seal interface can be essentially free of an energizing element.

The energizing element can include, for example, a spring, a compressed body such as a rubber ring, or a combination thereof. In a particular embodiment, the spring can include a U-shaped spring, a V-shaped spring, or a combination thereof.

In certain instances, the body of the seal can be reflectively symmetrical about a centerline. The centerline can extend perpendicular to a central axis of the seal. The centerline can intersect the central section of the seal.

In accordance with another aspect, a seal assembly can include an outer component defining a bore and an inner component disposed within the bore of the outer component. A seal can be disposed between the inner and outer components and include a central section, and first and second seal interfaces extending from the central section. In an embodiment, the central section can include a storage area adapted to contain leaked fluid during operation of the seal assembly. In a more particular embodiment, the entire central section can be defined by a storage area. The storage area can extend an entire distance, or substantially entire distance, between the first and second seal interfaces.

In accordance with another aspect, a high pressure fuel pump can generally include a housing defining a bore and a piston disposed in the bore of the housing. A seal can be disposed between the housing and piston and define a central section and first and second sealing interfaces extending from the central section.

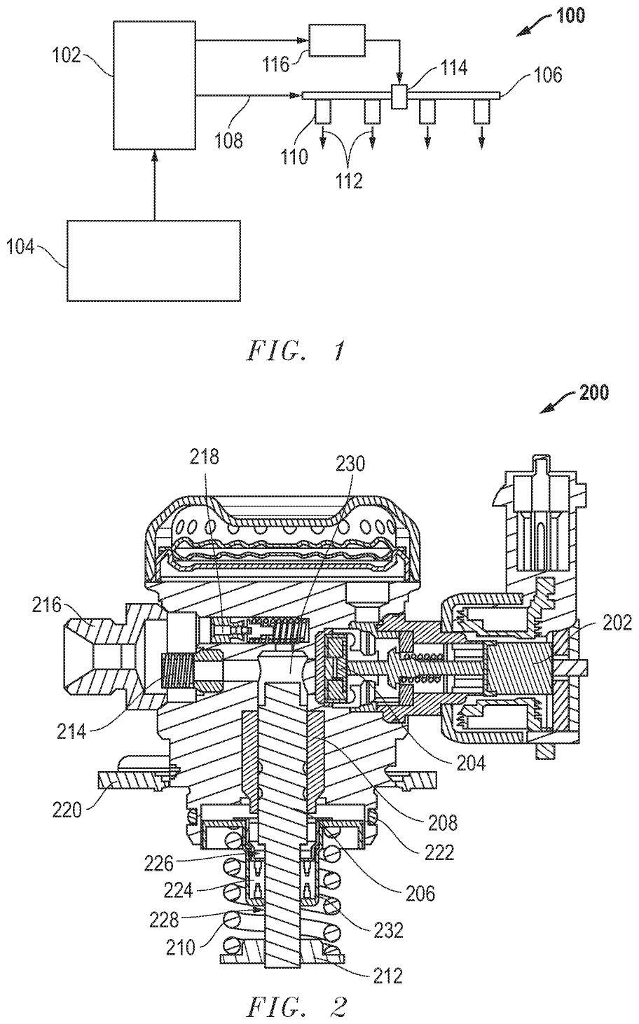

FIG. 1 includes a schematic view of a common rail system 100 including a pump 102 in fluid communication with a fuel tank 104 and a rail 106. The pump 102 can be adapted to pressurize fuel through one or more fuel lines 108 to the rail 106 where it can be dispensed through injectors 110. The rail 106 can include a common volume in fluid communication with all of the injectors 110. Pressurized fuel within the rail 106 can enter the injectors 110 and exit along flow paths 112 to one or more cylinders each containing a moving piston (not illustrated).

In an embodiment, the pump 102 can include a high-pressure pump adapted to bias fuel to the rail 106 at a pressure of at least 5 Megapascal (MPa), at least 6 MPa, at least 7 MPa, at least 8 MPa, at least 9 MPa, at least 10 MPa, at least 25 MPa, at least 50 MPa, at least 100 MPa, or at least 200 MPa. Fuel entering the pump 102 can optionally pass through one or more filters (not illustrated) disposed within the fuel tank 104 or along one or more fuel lines extending between the fuel tank 104 and the pump 102.

A pressure sensor 114 disposed in communication with the rail 106 can be adapted to detect fluid pressure within the rail 106 which can be monitored by a controller 116 to maintain the pressure within a desired range. In an embodiment, the controller 116 can be in communication with the pump 102 and adapted to adjust an operating condition of the pump 102 in response to the detected fluid pressure within the rail 106.

FIG. 2 includes a cross-sectional view of an exemplary pump 200 in accordance with an embodiment. As illustrated, the pump 200 can include a pressure control element 202, such as a solenoid, adapted to control fuel intake at an inlet valve 204. In an embodiment, the pressure control element 202 can be in communication with the controller 116 (FIG. 1) to maintain system pressure within a desired range. A piston 206 adapted to translate within a cylinder 208 can be biased by a spring 210 supported by a plate 212 to pressurize fuel through an outlet valve 214 to a high pressure fitting 216 in communication with the rail 106 (FIG. 1). The pump 200 can include a pressure relief valve 218 in communication with the outlet valve 214. In certain instances, the pump 200 can be coupled to an external support through a flange 220 or O-ring 222.

The piston 206 can be reciprocally driven within the cylinder 208 by a biasing element, such as by a cam disposed below the piston 206. As the piston 206 strokes away from a pressurizing volume 230 of the pump 200, fuel can be drawn into the pump 200 through the inlet valve 204 by pressure differential. The piston 206 can then stroke toward the volume 230, compressing the fuel and increasing internal pressure within the pump 200, to create a high pressure fuel supply exiting through the outlet valve 214 to the rail 106 (FIG. 1).

As the piston 206 translates within the cylinder 208 thereby increasing pressure within the pump 200, it is not uncommon for fuel to enter an annular gap between the piston 206 and cylinder 208. Left unsealed, the fuel could leak from the pump 200 and drip onto hot components, potentially igniting and causing a dangerous situation. To prevent egress of fuel from the pump 200, a seal 224 can be disposed between the piston 206 and an outer hardware 232 of the pump 200 or directly between the piston 206 and the cylinder 208. In such a manner, fuel can be contained within the pump 200 and leakage can be minimized or even eliminated.

In an embodiment, the seal 224 can be disposed between two regions of the pump 200 operating at different relative pressures. For instance, the seal 224 can be disposed between a first region 226 and a second region 228, wherein the first region 226 has a higher relative pressure as compared to the second region 228. The seal 224 can be adapted to maintain the higher pressure of the first region 226 or prevent leakage from the pump 200.

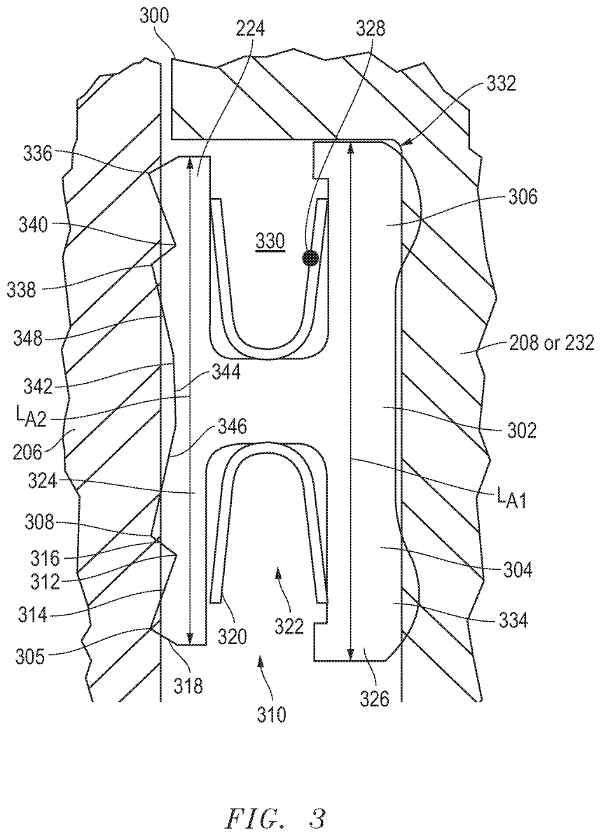

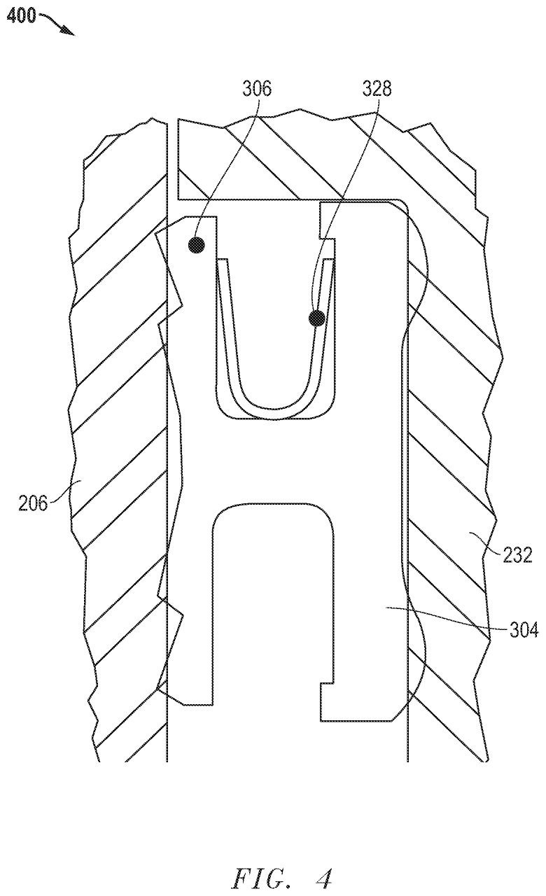

Referring to FIG. 3, in an embodiment the seal 224 can be disposed within a hardware 300, such as between the piston 206 and cylinder 208 or between the piston 206 and another outer hardware 232. The seal 224 can rest against the hardware 300, or a portion thereof. In an embodiment, the seal 224 can be compressed in at least a radial direction between components of the hardware 300. The seal 224 illustrated in FIG. 3 is shown in an unbiased state, overlapping hardware 300 that in use would cause seal 224 deformation.

In an embodiment, the seal 224 can include a central section 302, a first seal interface 304 extending from a first axial side of the central section 302, and a second seal interface 306 extending from a second axial side of the central section 302. In a particular instance, the first and second seal interfaces 304 and 306 can be reflectively symmetrical about a line extending perpendicular to an axis of the piston 206. The line can pass through the central section 302 of the seal 224. In another instance, the first and second seal interfaces 304 and 306 can lack reflective symmetry.

In an embodiment, the first seal interface 304 can include less than three sealing lips or less than two sealing lips adapted to contact the piston 206. In a particular embodiment, the first seal interface 304 can include two sealing lips, such as an edge lip 305 and a secondary lip 308 spaced apart from the edge lip 305. In an embodiment, the edge lip 305 can be disposed at, or adjacent to, an axial end 310 of the seal 224. The edge lip 305 can act as an initial sealing interface, serving as a first defense against leakage, such as fuel egress.

In an embodiment, the secondary lip 308 can be spaced apart from the edge lip 305 by a recessed portion 312 adapted to receive leaked fluid. In certain instances, leaked fluid can pass between the piston 206 and the cylinder 208, particularly during negative strokes of the piston 206 (i.e., when the piston 206 moves away from the pressurizing volume 230), and become stored in the recessed portion 312. In certain instances, the positive return stroke of the piston 206 (i.e., toward the pressurizing volume 230) can bias the leaked fluid from the recessed portion 312 to an area whereby the leaked fluid can reintegrate with high pressure fluid being biased by the pump 200.

In an embodiment, the recessed portion 312 can have a generally polygonal cross section, such as a triangular cross-sectional shape. In a particular embodiment, the recessed portion 312 can have a nonsymmetrical cross-sectional shape. For instance, the recessed portion 312 can include a first surface 314 and a second surface 316 that are not reflectively symmetrical about a center line of the recessed portion 312. In an embodiment, the first surface 314 can be disposed closer to the edge lip 305 and the second surface 316 can be disposed closer to the secondary lip 308. The first surface 314 can have a cross-sectional length different than the second surface 316. More particularly, the first surface 314 can have a cross-sectional length greater than the cross-sectional length of the second surface 316. By way of non-limiting example, the cross-sectional length of the first surface 314 can be at least 1.1 times greater than the cross-sectional length of the second surface 316, at least 1.2 times greater than the cross-sectional length of the second surface 316, at least 1.3 times greater than the cross-sectional length of the second surface 316, at least 1.4 times greater than the cross-sectional length of the second surface 316, at least 1.5 times greater than the cross-sectional length of the second surface 316, at least 2.0 times greater than the cross-sectional length of the second surface 316, or at least 3.0 times greater than the cross-sectional length of the second surface 316. In another example, the cross-sectional length of the first surface 314 can be no greater than 20 times greater than the cross-sectional length of the second surface 316. In certain instances, the use of a non-symmetrical recessed portion 312 can enhance natural pumping of leaked fluid back into the pump 200 during piston strokes, increase seal integrity, or both.

In certain instances, the first surface 314 can be disposed at a first relative angle different than a second relative angle of the second surface 316. For instance, in an embodiment, the first surface 314 can form a shallower angle with respect to the piston 206 as compared to the second surface 316. In such a manner, the edge lip 305 and secondary lip 308 can have a same height, or generally same height, as compared to one another, as measured perpendicular to an axis of the piston 206, while the seal 224 exhibits increased natural pumping efficiency of leaked fluid and increased seal integrity. In another embodiment, the edge lip 305 and secondary lip 308 can have different heights as compared to one another, as measured perpendicular to the axis of the piston 206. In a particular instance, the edge lip 305 can be taller than the secondary lip 308. For example, the edge lip 305 can be at least 0.01 mm taller than the secondary lip 308, at least 0.02 mm taller than the secondary lip 308, at least 0.05 mm taller than the secondary lip 308, or at least 0.1 mm taller than the secondary lip 308. In another example, the edge lip 305 can be less than 3 mm taller than the secondary lip 308, less than 2 mm taller than the secondary lip 308, less than 1.5 mm taller than the secondary lip 308, or less than 1.1 mm taller than the secondary lip 308.

In an embodiment, the edge lip 305 of the first seal interface 304 can be spaced apart from an axial end of the seal 224 by a chamfered edge 318. As the piston 206 reciprocates relative to the seal 224, the chamfered edge 318 can reduce seal-piston sticking. In addition, the chamfered edge 318 can provide increased surface pressure at the edge lip 305 by reducing contact area between the seal 224 and piston 206.

In an embodiment, the first seal interface 304 can include an energizing element 320 adapted to energize at least a portion of the seal 224. The energized element 320 can be disposed, for example, in a recessed portion 322 of the seal 224, such as a pocket extending from the axial end 310 toward the central section 302. In an embodiment, the recessed portion 322 can be disposed proximate to the axial end 310 of the seal 224. In a particular embodiment, the energizing element 320 can be visible from an external environment relative to the seal 224. In another embodiment, the energizing element 320 can be at least partially embedded within a body of the seal 224. For instance, the energizing element 320 can be at least partially encapsulated within the seal 224.

In certain instances, the energizing element 320 can include a spring, a compressed body such as a rubber ring, or a combination thereof. In an embodiment, the spring can include a U-shaped spring, a V-shaped spring, or any combination thereof. In an embodiment, the energizing element 320 can bias first and second arms 324 and 326 of the first seal interface 304 in radially inward and outward directions, respectively. In a particular embodiment, the energizing element 320 can contact the central section 302 of the seal 224. For example, a central most portion of the energizing element 320 can be disposed along an innermost portion of the recessed portion 322.

In an embodiment, the energizing element 320 can contact the seal body along an entire seal-energizing element interface. In another embodiment, the energizing element 320 can be spaced apart from the body of the seal at one or more locations. In a particular instance, biasing pressure generated on the first seal interface 304 by the energizing element 320 can be greatest at a location spaced apart from the central section 302, such as at locations near the axial end 310 of the seal 224.

In certain embodiments, the first seal interface 304 can further include a bump 334 disposed along an outer surface of the seal 224. In an embodiment, the bump 334 can be disposed proximate to the axial end 310 of the seal 224. In an embodiment, the bump 334 can have an arcuate cross-sectional shape. In another embodiment, the bump 334 can be contoured to include polygonal portions, arcuate portions, or a combination thereof. In certain instances, the bump 334 can increase sealing integrity.

In an embodiment, the second seal interface 306 can include any number of similar or different features as compared to the first seal interface 304. For instance, in an embodiment, the second seal interface 306 can include an energizing element 328 disposed in a recessed portion 330 extending from an axial end 332 of the seal 224. By way of another example, in an embodiment, the second seal interface 306 can include an edge lip 336 and a secondary lip 338 spaced apart by a recessed portion 340.

In an embodiment, the central section 302 of the seal 224 can include a concave cross-sectional profile. In a more particular embodiment, the central section 302 can retain a concave-cross-sectional profile in the installed state within the hardware, such as within the pump 200 between the piston 206 and outer hardware 232. In a more particular embodiment, a smallest thickness of the seal 224, as measured perpendicular to an axial length of the seal 224, can be disposed in the central section 302 of the seal 224.

In certain instances, the central section 302 can define a storage area 342 disposed between the seal 224 and the inner or outer component (e.g., the piston 206 or the outer hardware 232). The storage area 342 can have a volumetric capacity different from, such as greater, than a volumetric capacity of the recessed portion 312 on the first seal interface 304, as measured in the installed state, the uninstalled state, or both. In an embodiment, the storage area 342 can be adapted to receive or store fluid leaking past the recessed portion 312 of the first seal interface 304.

In an embodiment, the storage area 342 can include a continuously arcuate profile, as viewed in the installed state, the uninstalled state, or both. In another embodiment, the storage area 342 can have a generally recessed cross-sectional shape, including for example, a middle portion 344 and two end portions 346 and 348. In a particular embodiment, at least one of the end portions 346 and 348 can extend an entire distance between the middle portion 344 and a corresponding secondary lip 308 or 338 of the first or second seal interface 304 or 306. In a more particular embodiment, both end portions 346 and 348 can extend the entire distance between the middle portion 344 and the corresponding secondary lips 308 and 338. In a particular embodiment, at least one of the end portions 346 and 348 can extend onto the first or second seal interface 304 or 306, respectively. In certain instances, the at least one of the end portions 346 and 348 can lie along a generally straight line, as measured between the middle portion 344 and the corresponding secondary lip 308 or 338, in the installed state, uninstalled state, or both.

In an embodiment, the middle portion 344 of the central section 302 can be disposed entirely between the energizing elements 320 and 328. In another embodiment, the middle portion 344 of the central section 302 can be disposed entirely between the first and second seal interfaces 304 and 306. In yet a further embodiment, the middle portion 344 of the central section 302 can be disposed entirely within the central section 302.

In an embodiment, during operation the middle portion 344 of the storage area 342, a portion of the middle portion 344, or another portion of the storage area 342, can be spaced apart from the piston 206. That is, for example, the middle portion 344 can remain adapted to receive leaked fluid and prevent egress of leaked fluid from the pump 200.

In an embodiment, the seal 224 can define a first axial length, L_{A1}, as measured along an outer surface of the annular seal, and a second axial length, L_{A2}, as measured along an inner surface of the annular seal, that are different from one another. In a particular embodiment, L_{A1} can be greater than L_{A2}. For example, L_{A1} can be at least 1.01 L_{A2}, at least 1.02 L_{A2}, at least 1.03 L_{A2}, at least 1.04 L_{A2}, or at least 1.05 L_{A2}. In another embodiment, L_{A1} can be no greater than 1.4 L_{A2}, no greater than 1.3 L_{A2}, no greater than 1.2 L_{A2}, or no greater than 1.1 L_{A2}.

FIG. 4 includes a seal 400 in accordance with another embodiment. As illustrated, the seal 400 is disposed between the piston 206 and hardware 232. The second seal interface 306 can include the energizing element 328 and the first seal interface 304 can be essentially free of an energizing element. In an embodiment, the seal 400 can be adapted to be utilized in a system wherein the first seal interface 304 is in fluid communication with a first region 226 (FIG. 2) having a relatively higher pressure and the second seal interface 306 is in fluid communication with a second region 228 (FIG. 2) having a relatively lower pressure. In such a manner, the seal 400 can isolate the first and second regions 226 and 228 from one another with only one of the first and second seal interfaces 304 or 306 including an energizing element.

### Embodiment 1

An annular seal comprising:
a central section;
a first seal interface extending from a first axial side of the central section; and
a second seal interface extending from a second axial side of the central section,
wherein the first and second seal interfaces each include less than three sealing lips, and
   wherein at least a portion of the central section is adapted to be spaced apart from a surface of a hardware in an installed state.

### Embodiment 2

The annular seal of embodiment 1, wherein at least one of the first and second seal interfaces comprises an energizing element.

### Embodiment 3

The annular seal of embodiment 1, wherein the second seal interface comprises an energizing element, and wherein the first seal interface is essentially free of an energizing element.

### Embodiment 4

The annular seal of embodiment 3, wherein the annular seal is adapted to be disposed between a first region of a hardware and a second region of a hardware, wherein the first region has a higher pressure than the second region, and wherein the second seal interface is adapted to be disposed on a side of the annular seal closer to the first region.

### Embodiment 5

The annular seal of any one of the preceding embodiments, wherein the sealing lips comprise an edge lip adjacent to an axial end of the annular seal and a secondary lip spaced apart from the edge lip by a recessed portion.

### Embodiment 6

The annular seal of embodiment 5, wherein the recessed portion has a generally polygonal cross section.

### Embodiment 7

The annular seal of any one of embodiments 5 and 6, wherein the recessed portion comprises a first surface and a second surface, wherein the first surface is disposed closer to the edge lip and the second surface is disposed closer to the secondary lip, and wherein the first surface is bigger than the second surface.

### Embodiment 8

The annular seal of any one of embodiments 5-7, wherein the edge lip is spaced apart from an axial end of the annular seal by a chamfered edge of the annular seal.

### Embodiment 9

The annular seal of any one of the preceding embodiments, wherein the annular seal comprises a first axial length, L_{A1}, as measured along an outer surface of the annular seal, and a second axial length, L_{A2}, as measured along an inner surface of the annular seal, and wherein L_{A1} is different than L_{A2}.

### Embodiment 10

The annular seal of embodiment 9, wherein L_{A1} is at least 1.01 L_{A2}, at least 1.02 L_{A2}, at least 1.03 L_{A2}, at least 1.04 L_{A2}, or at least 1.05 L_{A2}.

### Embodiment 11

The annular seal of any one of the preceding embodiments, wherein the central section comprises a concave cross-sectional profile.

### Embodiment 12

The annular seal of any one of the preceding embodiments, wherein a smallest thickness of the annular seal, as measured perpendicular to an axial length of the annular seal, is disposed in the central section of the annular seal.

### Embodiment 13

A sealed assembly comprising:
an outer component defining a bore;
an inner component disposed within the bore of the outer component; and
an annular seal disposed between the inner and outer components, wherein the annular seal comprises:
   a central section;
   a first seal interface extending from a first axial side of the central section; and
   a second seal interface extending from a second axial side of the central section,
   wherein the first and second seal interfaces each include less than three sealing lips, and wherein at least a portion of the central section is spaced apart from a surface of the inner component.

### Embodiment 14

The sealed assembly of embodiment 13, wherein the inner component is adapted to rotate relative to the outer component, translate relative to the outer component, or both.

### Embodiment 15

The sealed assembly of any one of embodiments 13 and 14, wherein the central section comprises a concave cross-sectional profile in the installed state.

### Embodiment 16

The sealed assembly of any one of embodiments 13-15, wherein the first seal interface is in fluid communication with a first region of the assembly and the second seal interface is in fluid communication with a second region of the assembly, and wherein the first region has a higher pressure than the second region.

### Embodiment 17

The sealed assembly of embodiment 16, wherein the second seal interface comprises an energizing element, and wherein the first seal interface is essentially free of an energizing element.

### Embodiment 18

The sealed assembly of embodiment 17, wherein the energizing element comprises a spring, a compressed body such as a rubber ring, or a combination thereof.

### Embodiment 19

The sealed assembly of embodiment 18, wherein the spring comprises a U-shaped spring, a V-shaped spring, or a combination thereof.

### Embodiment 20

The sealed assembly of any one of embodiments 13-19, wherein a body of the annular seal is reflectively symmetrical about a centerline.

### Embodiment 21

The sealed assembly of any one of embodiments 13-20, wherein the central section defines a storage area between the annular seal and the inner or outer component, and wherein a volume of the storage area is greater than a volume of a recessed portion disposed between adjacent sealing lips of the first seal interface.

### Embodiment 22

The sealed assembly of embodiment 21, wherein the volume of the void is greater than a volume of a recessed portion disposed between adjacent sealing lips of the second seal interface.

### Embodiment 23

A seal assembly comprising:
an outer component defining a bore;
an inner component disposed within the bore of the outer component; and
an annular seal disposed between the inner and outer components, wherein the annular seal comprises:
   a central section;
   a first seal interface extending from a first axial side of the central section; and
   a second seal interface extending from a second axial side of the central section,
   wherein the central section comprises a storage area adapted to contain leaked fluid during operation of the seal assembly.

### Embodiment 24

The seal assembly of embodiment 23, wherein the storage area comprises a concave portion, as viewed in cross section.

### Embodiment 25

The seal assembly of any one of embodiments 23 and 24, wherein the storage area extends continuously from the first seal interface to the second seal interface.

### Embodiment 26

The seal assembly of any one of embodiments 23-25, wherein the storage area defines a volume, as measured when the annular seal is disposed between the outer and inner components, greater than a volume of a recessed portion disposed between adjacent sealing lips of the first seal interface.

### Embodiment 27

The seal assembly of any one of embodiments 23-26, wherein the second seal interface comprises an energizing element, and wherein the first seal interface is essentially free of an energizing element.

### Embodiment 28

A high pressure fuel pump comprising:
a housing defining a bore;
a piston disposed in the bore of the housing; and
an annular seal disposed between the piston and housing, wherein the annular seal comprises:
   a central section;
   a first seal interface extending from a first axial side of the central section; and
   a second seal interface extending from a second axial side of the central section,
   wherein:
      the central section comprises a storage area adapted to contain leaked fluid during operation of the high pressure common rail system, or
      the first and second seal interfaces each include less than three sealing lips, and wherein at least a portion of the central section is spaced apart from a surface of the piston, or
      a combination thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. An annular seal comprising:
a central section;
a first seal interface extending from a first axial side of the central section; and
a second seal interface extending from a second axial side of the central section,
wherein the first and second seal interfaces each include less than three sealing lips, and
wherein at least a portion of the central section is adapted to be spaced apart from a surface of a hardware in an installed state.

2. The annular seal of claim 1, wherein at least one of the first and second seal interfaces comprises an energizing element.

3. The annular seal of claim 1, wherein the second seal interface comprises an energizing element, and wherein the first seal interface is essentially free of an energizing element.

4. The annular seal of claim 3, wherein the annular seal is adapted to be disposed between a first region of a hardware and a second region of a hardware, wherein the first region has a higher pressure than the second region, and wherein the second seal interface is adapted to be disposed on a side of the annular seal closer to the first region.

5. The annular seal of claim 1, wherein the sealing lips comprise an edge lip adjacent to an axial end of the annular seal and a secondary lip spaced apart from the edge lip by a recessed portion.

6. The annular seal of claim 5, wherein the recessed portion has a generally polygonal cross section.

7. The annular seal of claim 5, wherein the recessed portion comprises a first surface and a second surface, wherein the first surface is disposed closer to the edge lip and the second surface is disposed closer to the secondary lip, and wherein the first surface is bigger than the second surface.

8. The annular seal of claim 5, wherein the edge lip is spaced apart from an axial end of the annular seal by a chamfered edge of the annular seal.

9. The annular seal of claim 1, wherein the central section comprises a concave cross-sectional profile.

10. A sealed assembly comprising:
an outer component defining a bore;
an inner component disposed within the bore of the outer component; and
an annular seal disposed between the inner and outer components, wherein the annular seal comprises:
a central section;
a first seal interface extending from a first axial side of the central section; and
a second seal interface extending from a second axial side of the central section,
wherein the first and second seal interfaces each include less than three sealing lips, and wherein at least a portion of the central section is spaced apart from a surface of the inner component.

11. The sealed assembly of claim 10, wherein the inner component is adapted to rotate relative to the outer component, translate relative to the outer component, or both.

12. The sealed assembly of claim 10, wherein the first seal interface is in fluid communication with a first region of the assembly and the second seal interface is in fluid communication with a second region of the assembly, and wherein the first region has a higher pressure than the second region.

13. The sealed assembly of claim 12, wherein the second seal interface comprises an energizing element, and wherein the first seal interface is essentially free of an energizing element.

14. The sealed assembly of claim 13, wherein the energizing element comprises a spring, a compressed body such as a rubber ring, or a combination thereof.

15. The sealed assembly of claim 14, wherein the spring comprises a U-shaped spring, a V-shaped spring, or a combination thereof.

16. The sealed assembly of claim 10, wherein the central section defines a storage area between the annular seal and the inner or outer component, and wherein a volume of the storage area is greater than a volume of a recessed portion disposed between adjacent sealing lips of the first seal interface.

17. A seal assembly comprising:
an outer component defining a bore;
an inner component disposed within the bore of the outer component; and
an annular seal disposed between the inner and outer components, wherein the annular seal comprises:
a central section;
a first seal interface extending from a first axial side of the central section; and
a second seal interface extending from a second axial side of the central section,
wherein the central section comprises a storage area adapted to contain leaked fluid during operation of the seal assembly.

18. The seal assembly of claim 17, wherein the storage area comprises a concave portion, as viewed in cross section.

19. The seal assembly of claim 17, wherein the storage area extends continuously from the first seal interface to the second seal interface.

20. The seal assembly of claim 17, wherein the second seal interface comprises an energizing element, and wherein the first seal interface is essentially free of an energizing element.
